(19) United States
(12) Patent Application Publication
(10) Pub. No.: US 2003/0236315 A1
(43) Pub. Date: Dec. 25, 2003

(54) Foamed isocyanate-based polymer having improved hardness properties and process for production thereof

(75) Inventors: Min Xie, Mississauga (CA); Robert A. Kee, Wheatley (CA); Ferdiemar N. Valentin, Woodbridge (CA); Jeffrey D. van Heumen, Guelph (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Woodbridge Foam Corporation

(21) Appl. No.: 10/352,182

(22) Filed: Jan. 28, 2003

Related U.S. Application Data
(60) Provisional application No. 60/351,395, filed on Jan. 28, 2002.

(51) Int. Cl. C08G 18/00

(52) U.S. Cl. 521/155

(57) ABSTRACT

In one of its aspects, the present invention relates to a foamed isocyanate-based polymer derived from a reaction mixture comprising toluene diisocyanate, wherein the foam has a compression force deformation of at least about 50 kPa at 30% deflection when measured pursuant to ASTM 3574 and a density of less than about 45 kg/m³. In another of its aspects, the present invention relates to a process for producing a foamed isocyanate-based polymer comprising the steps of: contacting an isocyanate comprising toluene diisocyanate, an active hydrogen-containing compound, a dendritic macromolecule and a blowing agent to form a reaction mixture; and expanding the reaction mixture to produce the foamed isocyanate-based polymer; wherein at least a 15% by weight of the dendritic macromolecule may be mixed with a polyether polyol having an OH number less than about 40 mg KOH/g to form a stable liquid at 23° C.

### CROSS-REFERENCE TO RELATED APPLICATION

The present application claims the benefit under 35 U.S.C. §119(e) of provisional patent application Ser. No. 60/351,395, filed Jan. 28, 2002, the contents of which are hereby incorporated by reference.

### BACKGROUND OF THE INVENTION

1. Field of the Invention

In one of its aspects, the present invention relates to a foamed isocyanate-based polymer having improved hardness properties. In another of its aspects, the present invention relates to a process for the production of such a foamed isocyanate-based polymer. In yet another of its aspects, the present invention relates to a method for improving the hardness characteristics of an isocyanate-based rigid or semi-rigid foam. In yet another of its aspects, the present invention provides a relatively low density toluene diisocyanate-based (TDI) foam.

2. Description of the Prior Art

Isocyanate-based polymers are known in the art. Generally, those of skill in the art understand isocyanate-based polymers to be polyurethanes, polyureas, polyisocyanurates and mixtures thereof.

It is also known in the art to produce foamed isocyanate-based polymers. Indeed, one of the advantages of isocyanate-based polymers compared to other polymer systems is that polymerization and foaming can occur in situ. This results in the ability to mould the polymer while it is forming and expanding.

One of the conventional ways to produce a polyurethane foam is known as the “one-shot” technique. In this technique, the isocyanate, a suitable polyol, a catalyst, water (which acts as a reactive “blowing” agent and can optionally be supplemented with one or more physical blowing agents) and other additives are mixed together at once using, for example, impingement mixing (e.g., high pressure). Generally, if one were to produce a polyurea, the polyol would be replaced with a suitable polyamine. A polyisocyanurate may result from cyclotrimerization of the isocyanate component. Urethane modified polyureas or polyisocyanurates are known in the art. In either scenario, the reactants would be intimately mixed very quickly using a suitable mixing technique.

Another technique for producing foamed isocyanate-based polymers is known as the “prepolymer” technique. In this technique, a prepolymer is produced by reacting polyol and isocyanate (in the case of a polyurethane) in an inert atmosphere to form a liquid polymer terminated with reactive groups (e.g., isocyanate moieties and active hydrogen moieties). To produce the foamed polymer, the prepolymer is thoroughly mixed with a lower molecular weight polyol (in the case of producing a polyurethane) or a polyamine (in the case of producing a modified polyurea) in the presence of a curing agent and other additives, as needed.

Regardless of the technique used, it is known in the art to include a filler material in the reaction mixture. Conventionally, filler materials have been introduced into foamed polymers by loading the filler material into one or both of the liquid isocyanate and the liquid active hydrogen-containing compound (i.e., the polyol in the case of polyurethane, the polyamine in the case of polyurea, etc.). Generally, incorporation of the filler material serves the purpose of conferring so-called loaded building properties to the resulting foam product.

The nature and relative amounts of filler materials used in the reaction mixture can vary, to a certain extent, depending on the desired physical properties of the foamed polymer product, and limitations imposed by mixing techniques, the stability of the system and equipment imposed limitations (e.g., due to the particle size of the filler material being incompatible with narrow passages, orifices and the like of the equipment).

One known technique of incorporating a solid material in the foam product for the purpose of improving hardness properties involves the use of a polyol-solids dispersion, particularly one in the form of a graft copolymer polyol. As is known in the art, graft copolymer polyols are polyols, preferably polyether polyols, which contain other organic polymers. It is known that such graft copolymer polyols are useful to confer hardness (i.e., load building) to the resultant polyurethane foam compared to the use of polyols which have not been modified by incorporating the organic polymers. Within graft copolymer polyols, there are two main categories which may be discussed: (i) chain-growth copolymer polyols, and (ii) step-growth copolymer polyols.

Chain-growth copolymer polyols generally are prepared by free radical polymerization of monomers in a polyol carrier to produce a free radical polymer dispersed in the polyol carrier. Conventionally, the free radical polymer can be based on acrylonitrile or styrene-acrylonitrile (SAN). The solids content of the polyol is typically up to about 60%, usually in the range of from about 15% to about 40%, by weight of the total weight of the composition (i.e., free radical polymer and polyol carrier). Generally, these chain-growth copolymer polyols have a viscosity in the range of from about 2,000 to about 8,000 centipoise. When producing such chain-growth copolymer polyols, it is known to induce grafting of the polyol chains to the free-radical polymer.

Step-growth copolymer polyols generally are characterized as follows: (i) PHD (Polyharnstoff Disperion) polyols, (ii) PIPA (Poly Isocyanate Poly Addition) polyols, and (iii) epoxy dispersion polyols. PHD polyols are dispersions of polyurea particles in conventional polyols and generally are formed by the reaction of a diamine (e.g., hydrazine) with a diisocyanate (e.g., toluene diisocyanate) in the presence of a polyether polyol. The solids content of the PHD polyols is typically up to about 50%, usually in the range of from about 15% to about 40%, by weight of the total weight of the composition (i.e., polyurea particles and polyol carrier). Generally, PHD polyols have a viscosity in the range of from about 2,000 to about 6,000 centipoise. PIPA polyols are similar to PHD polyols but contain polyurethane particles instead of polyurea particles. The polyurethane particles in PIPA polyols are formed in situ by reaction of an isocyanate and alkanolamine (e.g., triethanolamine). The solids content of the PIPA polyols is typically up to about 80%, usually in the range of from about 15% to about 70%, by weight of the total weight of the composition (i.e., polyurethane particles and polyol carrier). Generally, PIPA polyols have a viscosity in the range of from about 4,000 to about 50,000 centipoise. See, for example, U.S. Pat. Nos. 4,374,209 and 5,292,778. Epoxy dispersion polyols are based on dispersions of cured epoxy resins in conventional based polyols. The epoxy particles are purportedly high modulus solids with improved hydrogen bonding characteristics.

Further information regarding useful graft copolymer polyols may be found, for example, in Chapter 2 of “Flexible Polyurethane Foams” by Herrington and Hock (1997) and the references cited therein.

It is known in the art that a large number of different isocyanate compounds can be used in formulations to produce isocyanate-based polymer foams. Notwithstanding this, the vast number of commercial plants which produce such foams utilize diphenylmethane diisocyanate (MDI), toluene diisocyanate (TDI) and/or mixtures thereof

With the conventional isocyanate-based polymer foam art there is a classes of foams conventionally referred to as rigid foam and semi-rigid foam. These foams typically are used in applications which require the foam to function in energy absorbing applications, structural applications and the like. Conventionally, molded rigid isocyanate-based polymer foams and semi-rigid isocyanate-based polymer foams are produced using MDI as the isocyanate on dedicated production lines. Generally, MDI has higher reactivity than TDI which allows for rapid cure and shorter in-mold time in the foam manufacturing process. Further, MDI generates higher hardness foam than TDI (i.e., the use of TDI as the isocyanate in the formulation will result in production of a flexible foam). Therefore, MDI is commonly used in the manufacture of rigid/semi-rigid isocyanate-based polymer foams. Unfortunately, due to its inherent structure, it is not possible to use MDI as the sole isocyanate in the formulation to produce an iscyanate-based polymer foam having a density lower than about 45 kg/m³. This is particularly disadvantageous when the foam product is used in automotive applications due to the increased weight of the foam part. Also, due to the inherent high reactivity and rapid cure of MDI-based formulation, reduced flowability is encountered which results in serious processing difficulties in large and complex molds. TDI-based formulations can be used to produce foams having a larger density range. Slower isocyanate reactivity allows for better management of the reaction profile resulting in improved flowability and blowing efficiency. Despite this, TDI-based formulations can not be used to produce rigid or semi-rigid isocyanate-based foams due to their inability to generate enough hardness to satisfy the intended design requirements.

Thus, it would be highly desirable to have an isocyanate based foam which is TDI-based, has the hardness profile of a conventional MDI-based rigid foam or a conventional MDI-based semi-rigid foam and has a density of less about 45 kg/m³.

### SUMMARY OF THE INVENTION

It is an object of the present invention to provide a novel isocyanate-based polymer foam which obviates or mitigates at least one of the above-mentioned disadvantages of the prior art.

It is another object of the present invention to provide a novel isocyanate-based polymer foam.

It is yet another object of the present invention to provide a novel process for production of an isocyanate-based polymer foam.

Accordingly, in one of its objects, the present invention provides a foamed isocyanate-based polymer derived from a reaction mixture comprising toluene diisocyanate, wherein the foam has a compression force deformation of at least about 50 kPa at 30% deflection when measured pursuant to ASTM 3574 and a density of less than about 45 kg/m³.

In yet another of its aspects, the present invention provides a process for producing a foamed isocyanate-based polymer comprising the steps of:

contacting an isocyanate comprising toluene diisocyanate, an active hydrogen-containing compound, a dendritic macromolecule and a blowing agent to form a reaction mixture; and

expanding the reaction mixture to produce the foamed isocyanate-based polymer;

wherein at least a 15% by weight of the dendritic macromolecule may be mixed with a polyether polyol having an OH number less than about 40 mg KOH/g to form a stable liquid at 23° C.

As used throughout this specification, the term “isocyanate-based polymer” is intended to mean, inter alia, polyurethane, polyurea and polyisocyanurate. Further, the terms “dendritic polymer” and “dendritic macromolecule” are used interchangeably throughout this specification. These materials are generally known in the art. See, for example, any one of:

Tomalia et al in Angew. Chem. Int. Ed. Engl. 29 pages 138-175 (1990);

U.S. Pat. No. 5,418,301 [Hult et al (Hult)]; and

U.S. Pat. No. 5,663,247 [Sörensen et al (Sörensen)].

The present inventors have surprisingly and unexpectedly discovered that a sub-group of dendritic macromolecules is particularly advantageous to produce TDI-based foams have a novel combination of properties. More particularly, the present inventors have surprisingly and unexpectedly determined that the introduction of a dendritic macromolecule in the foam formulation allows for the production of a rigid/semi-rigid foam utilizing TDI as the base isocyanate. The present invention allows for the production of rigid/semi-rigid TDI-based polymer foam at lower densities with improved flow ability and on any existing flexible foam production (e.g., molding) line. Preferably, the dendritic macromolecule is selected from a sub-group of dendritic macromolecules described in detail in U.S. provisional patent application No. 60/221,512 (filed on Jul. 28, 2000 and naming Pettersson et al. as inventors) and corresponding International Publication Number WO 02/10189 (filed in the name of Perstorp AB and published on Feb. 7, 2002).

Preferably, the dendritic macromolecule is characterized by the ability to mix at least about 15% by weight of the dendritic macromolecule with a polyether polyol having an OH number less than about 40 mg KOH/g to form a stable liquid at 23° C. As used throughout this specification, the term “stable liquid”, when used in connection with this solubility parameter of the dendritic macromolecule, is intended to mean that the liquid formed upon mixing the dendritic macromolecule and the polyol has a substantial constant light transmittance (transparent at one extreme and opaque at the other extreme) for at least 2 hours, preferably at least 30 days, more preferably a number of months, after production of the mixture. Practically, in one embodiment, the stable liquid will be in the form a clear, homogeneous liquid (e.g., a solution) which will remain as such over time. In another embodiment, the stable liquid will be in the form an emulsion of (at least a portion of) the dendritic macromolecule in the polyol which will remain as such over time—i.e., the dendritic macromolecule will not settle out over time.

### DETAILED DESCRIPTION OF THE PREFERRED EMBODIMENTS

The present invention is related to foamed isocyanate-based polymer and to a process for production thereof. Preferably, the isocyanate-based polymer is selected from the group comprising polyurethane, polyurea, polyisocyanurate, urea-modified polyurethane, urethane-modified polyurea, urethane-modified polyisocyanurate and urea-modified polyisocyanurate. As is known in the art, the term “modified”, when used in conjunction with a polyurethane, polyurea or polyisocyanurate means that up to 50% of the polymer backbone forming linkages have been substituted.

The present foamed isocyanate-based polymer preferably is produced from a reaction mixture which comprises an isocyanate comprising toluene diisocyanate, an active hydrogen-containing compound, a dendritic macromolecule and a blowing agent

In one embodiment, the toluene diisocyanate the sole isocyanate in the reaction mixture.

In another embodiment, the isocyanate comprises toluene diisocyanate and at least one other isocyanate. Preferably, in this embodiment, the reaction mixture comprises at least about 30% by weight toluene diisocyanate, with balance being made up of the other isocyanate. More preferably, in this embodiment, the reaction mixture comprises at least about 40% by weight toluene diisocyanate, with balance being made up of the other isocyanate. Even more preferably, in this embodiment, the reaction mixture comprises at least about 50% by weight toluene diisocyanate, with balance being made up of the other isocyanate. Most preferably, in this emodiment, the reaction mixture comprises at least about 75% by weight toluene diisocyanate, with balance being made up of the other isocyanate.

The precise nature of the at least one other isocyanate is not particularly restricted. Preferably, the other isocyanate is selected from the group comprising hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, chlorophenylene diisocyanates, diphenylmethane-4,4-diisocyanate, naphthalene-1,5-diisocyanate, triphenylmethane-4,4′,4″-triisocyanate, isopropylbenzene-alpha-4-diisocyanate and mixtures thereof. More preferably, the other isocyanate is selected from the group comprising 1,6-hexamethylene diisocyanate, 1,4-butylene diisocyanate, furfurylidene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl ethane diisocyanate, 1,5-naphthalene dilsocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof.

Most preferably, the other isocyanate is selected from the group comprising 2,4′-diphenylmethane diisocyanate, 4,4′-diphenylmethane diisocyanate and mixtures thereof. An example of this is a mixture comprising from about 15 to about 25 percent by weight 2,4′-diphenylmethane diisocyanate and from about 75 to about 85 percent by weight 4,4′-diphenylmethane diisocyanate.

Preferably, the toluene diisocyanate is selected from the group comprising 2,4-toluene diisocyanate, 2,6-toluene diisocyanate and mixtures thereof. More preferably, the toluene isocyanate is selected from the group comprising 2,4-toluene diisocyanate, 2,6-toluene diisocyanate and mixtures thereof, for example, a mixture comprising from about 75 to about 85 percent by weight 2,4-toluene diisocyanate and from about 15 to about 25 percent by weight 2,6-toluene diisocyanate.

The isocyanate (TDI, non-TDI (if present) or both) used in the present process may be used in the form of a prepolymer. Generally, a prepolymer may be prepared by reacting a stoichiometric excess of an isocyanate compound (as defined hereinabove) with an active hydrogen-containing compound (as defined hereinafter), preferably the polyhydroxyl-containing materials or polyols described below. In this embodiment, the polyisocyanate may be, for example, used in proportions of from about 30 percent to about 200 percent stoichiometric excess with respect to the proportion of hydroxyl in the polyol. Since the process of the present invention may relate to the production of polyurea foams, it will be appreciated that in this embodiment, the prepolymer could be used to prepare a polyurethane modified polyurea.

In another embodiment, the non-TDI isocyanate compound suitable for use in the process of the present invention may be selected from dimers and trimers of isocyanates and diisocyanates, and from polymeric diisocyanates having the general formula:

[ Q″(NCO)ᵢ]ⱼ

wherein both i and j are integers having a value of 2 or more, and Q″ is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also for example, British patent number 1,453,258, for a discussion of suitable isocyanates.

If the process is utilized to produce a polyurethane foam, the active hydrogen-containing compound is typically a polyol. The choice of polyol is not particularly restricted and is within the purview of a person skilled in the art. For example, the polyol may be a hydroxyl-terminated backbone of a member selected from the group comprising polyether, polyester, polycarbonate, polydiene and polycaprolactone. Preferably, the polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyols are selected from the group comprising adipic acid-ethylene glycol polyester, poly(butylene glycol), poly(propylene glycol) and hydroxyl-terminated polybutadiene—see, for example, British patent number 1,482,213, for a discussion of suitable polyols. Preferably, such a polyether polyol has a molecular weight in the range of from about 200 to about 10,000, more preferably from about 2,000 to about 7,000, most preferably from about 2,000 to about 6,000.

If the process is utilized to produce a polyurea foam, the active hydrogen-containing compound comprises compounds wherein hydrogen is bonded to nitrogen. Preferably such compounds are selected from the group comprising polyamines, polyamides, polyimines and polyolamines, more preferably polyamines. Non-limiting examples of such compounds include primary and secondary amine terminated polyethers. Preferably such polyethers have a molecular weight of greater than about 230 and a functionality of from 2 to 6. Such amine terminated polyethers are typically made from an appropriate initiator to which a lower alkylene oxide is added with the resulting hydroxyl terminated polyol being subsequently aminated. If two or more alkylene oxides are used, they may be present either as random mixtures or as blocks of one or the other polyether. For ease of amination, it is especially preferred that the hydroxyl groups of the polyol be essentially all secondary hydroxyl groups. Typically, the amination step replaces the majority but not all of the hydroxyl groups of the polyol.

The reaction mixture used to produce the present foamed isocyanate-based polymer typically will further comprise a blowing agent. As is known in the art water can be used as an indirect or reactive blowing agent in the production of foamed isocyanate-based polymers. Specifically, water reacts with the isocyanate forming carbon dioxide which acts as the effective blowing agent in the final foamed polymer product. Alternatively, the carbon dioxide may be produced by other means such as unstable compounds which yield carbon dioxide (e.g., carbamates and the like). Optionally, direct organic blowing agents may be used in conjunction with water although the use of such blowing agents is generally being curtailed for environmental considerations. The preferred blowing agent for use in the production of the present foamed isocyanate-based polymer comprises water.

It is known in the art that the amount of water used as an indirect blowing agent in the preparation of a foamed isocyanate-based polymer is conventionally in the range of from about 0.5 to as high as about 40 or more parts by weight, preferably from about 1.0 to about 10 parts by weight, based on 100 parts by weight of the total active hydrogen-containing compound content in the reaction mixture. As is known in the art, the amount of water used in the production of a foamed isocyanate-based polymer typically is limited by the fixed properties expected in the foamed polymer and by the tolerance of the expanding foam towards self structure formation.

The reaction mixture used to produce the present foamed isocyanate-based polymer typically will further comprise a catalyst. The catalyst used in the reaction mixture is a compound capable of catalyzing the polymerization reaction. Such catalysts are known, and the choice and concentration thereof in the reaction mixture is within the purview of a person skilled in the art. See, for example, U.S. Pat. Nos. 4,296,213 and 4,518,778 for a discussion of suitable catalyst compounds. Non-limiting examples of suitable catalysts include tertiary amines and/or organometallic compounds. Additionally, as is known in the art, when the objective is to produce an isocyanurate, a Lewis acid must be used as the catalyst, either alone or in conjunction with other catalysts. Of course it will be understood by those skilled in the art that a combination of two or more catalysts may be suitably used.

In a preferred aspect of the present invention a dendritic macromolecule is incorporated in the present foamed isocyanate-based polymer. Preferably, the dendritic macromolecule has the following characteristics:

an active hydrogen content of greater than about 3.8 mmol/g, more preferably greater than about 4.0 mmol/g, even more preferably in the range of from about 3.8 to about 10 mmol/g; even more preferably in the range of from about 3.8 to about 7.0 mmol/g; even more preferably in the range of from about 4.0 to about 8.0 mmol/g; most preferably in the range of from about 4.4 to about 5.7 mmol/g;

an active hydrogen functionality of at least about 8; more preferably at least about 16; even more preferably in the range of from about 16 to about 70; even more preferably in the range of from about 18 to about 60; even more preferably in the range of from about 17 to about 35; most preferably in the range of from about 20 to about 30;

at least about 15%, more preferably from about 15% to about 50%, even more preferably from about 15% to about 40%, even more preferably from about 15% to about 30%, by weight of the dendritic macromolecule may be mixed with a polyether polyol having an OH number less than about 40, more preferably from about 25 to about 35, mg KOH/g to form a stable liquid at 23° C.

Further details on the dendritic macromolecule may be obtained from U.S. provisional patent application No. 60/221,512 (filed on Jul. 28, 2000 and naming Pettersson et al. as inventors) and corresponding International Publication Number WO 02/10189 (filed in the name of Perstorp AB and published on Feb. 7, 2002).

As will be clearly understood by those of skill in the art, it is contemplated that conventional additives in the polyurethane foam art can be incorporated in the reaction mixture created during the present process. Non-limiting examples of such additives include: surfactants (e.g., organo-silicone compounds available under the tradename L-540 Union Carbide), cell openers (e.g., silicone oils), extenders (e.g., halogenated paraffins commercially available as Cereclor S45), cross-linkers (e.g., low molecular weight reactive hydrogen-containing compositions), pigments/dyes, flame retardants (e.g., halogenated organo-phosphoric acid compounds), inhibitors (e.g., weak acids), nucleating agents (e.g., diazo compounds), anti-oxidants, and plasticizers/stabilizers (e.g., sulphonated aromatic compounds). The amounts of these additives conventionally used would be within the purview of a person skilled in the art.

The manner by which the active hydrogen-containing compound, isocyanate, blowing agent, dendritic macromolecule and catalyst are contacted in the first step of the present process is not particularly restricted. Thus, it is possible to preblend the components in a separate tank which is then connected to a suitable mixing device for mixing with the blowing agent and catalyst. Alternatively, it is possible to preblend the active hydrogen-containing compound (e.g., polyol) with the blowing agent, catalyst and other additives, if present, to form a resin. This resin preblend could then be fed to a suitable mixhead (high pressure or low pressure) which would also receive an independent stream of the isocyanate.

Once the active hydrogen-containing compound, isocyanate, blowing agent, dendritic macromolecule and catalyst have been contacted and, ideally, mixed uniformly, a reaction mixture is formed. This reaction mixture is then expanded to produce the present isocyanate-based polyurethane foam. As will be apparent to those of skill in the art, the process of the present invention is useful in the production of slabstock foam, molded articles and the like. The manner by which expansion of the reaction mixture is effected will be dictated by the type of foam being produced.

The product of the present process is foamed isocyanate-based polymer derived from a reaction mixture comprising toluene diisocyanate, wherein the foam has a compression force deformation of at least about 50 kPa at 30% deflection when measured pursuant to ASTM 3574 and a density of less than about 45 kg/m³.

Preferably, the foam has a compression force deformation of at least about 70 kPa at 30% deflection when measured pursuant to ASTM 3574, more preferably at least about 90 kPa at 30% deflection when measured pursuant to ASTM 3574, even more preferably at least about 100 kPa at 30% deflection when measured pursuant to ASTM 3574, most preferably at least about 120 kPa at 30% deflection when measured pursuant to ASTM 3574.

Preferably, the foam has a density in the range of from about 25 to about 45 kg/m³, more preferably in the range of from about 30 to about 45 kg/m³, most preferably in the range of from about 35 to about 45 kg/m³.

The following Examples illustrate the use of the dendritic polymer in a typical isocyanate-based high resilience (HR) based foam. In each of the following Examples, the isocyanated-based polymer foam was prepared by the pre-blending of all resin ingredients including: polyols, copolymer polyols, catalysts, water and surfactants as well as the dendritic macromolecule. The resin blend was then mixed with isocyanate at a desired index using a shear mixer and dispensed into a preheated test mold (65-70° C.) with the dimensions of 15″×15″×4″ or 10″×10″×4″. The mold was then closed and the mixture was left in the mold for approximately 6 minutes. The resulting foam product was then removed and, after conventional post-production conditioning, the properties of interest were measured. Specifically, compression force deformation at 30% deflection was measured pursuant to ASTM 3574 and density was measured in a conventional manner. This methodology will be referred to in the following Examples as the General Procedure.

In the Examples, the following materials were used:

E837, a base polyol, commercially available from Lyondell;

E850, a 43% solids content copolymer (SAN) polyol, commercially available from Bayer;

H3100, a dendritic macromolecule commercially available from Perstorp;

V-4701, a base polyol, commercially available from Dow;

Arcol 3128, a 21% solids content copolymer (AN) polyol, commercially available from Bayer;

V230-660, a polyol, commercially available from Dow;

P1158, a polyol, commercially available from BASF;

V4053, a polyol, commercially available from Dow;

DEOA LF, diethanolamine, a cross-linking agent commercially available from Air Products;

Glycerin, a cross-linking agent, commercially available from Van Waters & Rogers; Water, indirect blowing agent;

Niax A-1, a blowing catalyst, commercially available from Witco OSi;

Dabco 33LV, a gelation catalyst, commercially available from Air Products;

Polycat 12, a skin cure catalyst, commercially available from Air Products;

Polycat 77, a balanced blow/gel catalyst, commercially available from Air Products;

DC 5169, a surfactant, commercially available from Air Products;

Y-10184, a surfactant, commercially available from Witco OSi;

B 8719, a surfactant, commercially available from Th. Goldschmidt;

Lupranate T80, isocyanate (TDI), commercially available from BASF; and

Mondur MR, isoycanate (MDI), commercially available from Bayer.

Unless otherwise stated, all parts reported in the Examples are parts by weight.

The Examples below illustrate the unique benefits achieved by the introduction of a dendritic macromolecule into a TDI-based polyurethane foam.

### EXAMPLES 1-3

In Examples 1-3, a series of polyurethane foams was produced using the formulations set out in Table 1 and the General Procedure described above. As will be apparent to those of skill in the art, the formulations in Table 1 did not contain any dendritic macromolecule (H310). Example 1 illustrates the maximum achievable hardness with conventional TDI flexible molded foam technology. Example 2 illustrates the maximum achievable hardness using TDI in a rigid/semi-rigid polyurethane foam. Example 3 represents a typical molded rigid/semi rigid polyutherane foam using MDI as the main isocyanate. Clearly, the difference in measured CFD hardness between polyurethane foams prepared with TDI (Examples 1 and 2) and a typical MDI based rigid foam (Example 3) is significant, thus illustrating the significant limitation in using TDI in a rigid/semi-rigid PUF application. Examples 1-3 are provide for comparative purposes only.

### EXAMPLES 4-6

In Examples 4-6, a series of polyurethane foams was produced using the formulations set out in Table 2 and the General Procedure described above. As will be apparent to those of skill in the art, the polyurethane foams were produced using a typical rigid PUF formulation incorporating TDI-MDI isocyanate blends. Various MDI substitutions were used to demonstrate the impact of the MDI on hardness of the PU foam with decreasing amount of MDI. Noticeably, the measured CFD are still well below the measured CFD for the typical MDI based rigid foam shown in Example 3. Also, the CFD decreased with the reducing amount of MDI. Once more, TDI could not provide hardness in the rigid/semi-rigid PUF application. Examples 4-6 are provide for comparative purposes only.

### EXAMPLES 7-9

In Examples 7-9 a series of polyurethane foams was produced using the formulations set out in Table 3 and the General Procedure described above. As will be apparent to those of skill in the art and as set out in the formulations for Examples 7-9 in Table 3, the dendritic macromolecule was added to the formulations and TDI was the main isocyanate. For illustrative purposes, the corresponding information for Example 3 has been reproduced in Table 3 and represents a typical formulation for production of a molded rigid PUF using MDI as an isocyanate. Example 8 and 9 incorporate into the resin formulation of Example 7 typical flexible PUF components at various MDI substitutions and isocyanate index. Surprisingly, also by using conventional flexible PUF components, a similar rigid type PUF can also be achieved in Example 8 and 9.

### EXAMPLES 10-15

In Examples 10-15 a series of polyurethane foams was produced on a pilot plant line using the formulations set out in Table 4. Example 10-15 in Table 4, similar to Example 8 and 9, introduced the dendritic macromolecule using typical flexible PUF components with TDI as the main isocyanate while varying the MDI substitutions and index.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1

| | Example | | |
|---|---|---|---|
| Ingredient | 1 | 2 | 3 |
| E-850 | 100 | 46.24 | 46.24 |
| V-4701 | 0 | 19.21 | 19.21 |
| 3128 | 0 | 23.52 | 23.52 |
| H3100 | 0 | 0 | 0 |
| V230-660 | 0 | 9.12 | 9.12 |
| DEOA-LF | 1.20 | 0 | 0 |
| P1158 | 0 | 1.89 | 1.89 |
| H₂O | 1.88 | 3.02 | 3.02 |
| 33-LV | 0.50 | 0.10 | 0.10 |
| NIAX A-1 | 0.08 | 0.05 | 0.05 |
| PC12 | 0 | 1.00 | 1.00 |
| PC77 | 0 | 0.05 | 0.05 |
| Y10184 | 1.00 | 0 | 0 |
| 8719 | 0 | 0.46 | 0.46 |
| Total | 104.66 | 104.66 | 104.66 |
| % SAN | 41.09% | 23.72% | 23.72% |
| TDJ (wt %) | 100 | 100 | 0 |
| Mondur MR (MDI) (wt %) | 0 | 0 | 100 |
| Index | 100 | 100 | 100 |
| Density (kg/m³) | 58 | 57 | 62 |
| 30% CFD (kPa) | 19.77 | 34.30 | 101.69 |

TABLE 2

| | Example | | |
|---|---|---|---|
| Ingredient | 4 | 5 | 6 |
| E-850 | 46.24 | 46.24 | 46.24 |
| V-4701 | 19.21 | 19.21 | 19.21 |
| 3128 | 23.52 | 23.52 | 23.52 |
| V230-660 | 9.12 | 9.12 | 9.12 |
| P1158 | 1.89 | 1.89 | 1.89 |
| H₂O | 3.02 | 3.02 | 3.02 |
| 33-LV | 0.10 | 0.10 | 0.10 |
| NIAX A-1 | 0.05 | 0.05 | 0.05 |
| PC12 | 1.00 | 1.00 | 1.00 |
| PC77 | 0.05 | 0.05 | 0.05 |
| 8719 | 0.46 | 0.46 | 0.46 |
| Total | 104.66 | 104.66 | 104.66 |
| % SAN | 23.72% | 23.72% | 23.72% |
| TDI (wt %) | 80 | 70 | 60 |
| Mondur MR (MDI) (wt %) | 20 | 30 | 40 |
| Index | 100 | 100 | 100 |
| Density (kg/m³) | 58 | 58 | 58 |
| 30% CFD (Kpa) | 41.04 | 48.54 | 50.28 |

TABLE 3

| | Example | | | |
|---|---|---|---|---|
| Ingredient | 3 | 7 | 8 | 9 |
| E-850 | 46.24 | 74.90 | 58.68 | 58.68 |
| E-837 | 0 | 0 | 22.50 | 22.50 |
| V-4701 | 19.21 | 0 | 0 | 0 |
| 3128 | 23.52 | 0 | 0 | 0 |
| H3100 | 0 | 27.84 | 20.88 | 20.88 |
| V230-660 | 9.12 | 0 | 0 | 0 |
| DEOA-LF | 0 | 0 | 0.30 | 0.30 |
| Glycerin | 0 | 0 | 0.15 | 0.15 |
| P1158 | 1.89 | 0 | 0 | 0 |
| H₂O | 3.02 | 0 | 1.04 | 1.04 |
| 33-LV | 0.10 | 0 | 0.10 | 0.10 |
| NIAX A-1 | 0.05 | 0 | 0.02 | 0.02 |
| PC12 | 1.00 | 0 | 0 | 0 |
| PC77 | 0.05 | 0.20 | 0.18 | 0.18 |
| Y10184 | 0 | 0.40 | 0.55 | 0.55 |
| DC5169 | 0 | 0 | 0.08 | 0.08 |
| 8719 | 0.46 | 0 | 0 | 0 |
| V4053 | 0 | 4.00 | 3.00 | 3.00 |
| Total | 104.66 | 107.43 | 107.48 | 107.48 |
| % SAN | 23.72% | 30.00% | 23.48% | 23.48% |
| TDI (wt %) | 0 | 100 | 100 | 80 |
| Mondur MR (MDI) (wt %) | 100 | 0 | 0 | 20 |
| Index | 100 | 100 | 110 | 100 |
| Density (kg/m³) | 62 | 61 | 62 | 63 |
| 30% CFD (kPa) | 101.69 | 137.29 | 116.72 | 113.14 |

TABLE 4

| | Example | | | | | |
|---|---|---|---|---|---|---|
| Ingredient | 10 | 11 | 12 | 13 | 14 | 15 |
| E-850 | 58.68 | 58.68 | 58.68 | 58.68 | 58.68 | 58.68 |
| E-837 | 22.50 | 22.50 | 22.50 | 22.50 | 22.50 | 22.50 |
| H3100 | 20.88 | 20.88 | 20.88 | 20.88 | 20.88 | 20.88 |
| DEOA-LF | 0.30 | 0.30 | 0.30 | 0.30 | 0.30 | 0.30 |
| Glycerin | 0.15 | 0.15 | 0.15 | 0.15 | 0.15 | 0.15 |
| H₂O | 1.04 | 1.04 | 1.04 | 1.04 | 1.04 | 1.04 |
| 33-LV | 0.10 | 0.10 | 0.10 | 0.10 | 0.10 | 0.10 |
| NIAX A-1 | 0.02 | 0.02 | 0.02 | 0.02 | 0.02 | 0.02 |
| PC77 | 0.18 | 0.18 | 0.18 | 0.18 | 0.18 | 0.18 |
| Y10184 | 0.55 | 0.55 | 0.55 | 0.55 | 0.55 | 0.55 |
| DC5169 | 0.08 | 0.08 | 0.08 | 0.08 | 0.08 | 0.08 |
| V4053 | 3.00 | 3.00 | 3.00 | 3.00 | 3.00 | 3.00 |
| Total | 107.48 | 107.48 | 107.48 | 107.48 | 107.48 | 107.48 |
| % SAN | 23.48% | 23.48% | 23.48% | 23.48% | 23.48% | 23.48% |
| TDJ (wt %) | 100 | 80 | 70 | 60 | 50 | 80 |
| Mondur MR | 0 | 20 | 30 | 40 | 50 | 20 |
| (MDI) | | | | | | |
| (wt %) | | | | | | |
| Index | 110 | 100 | 100 | 100 | 100 | 110 |
| Density | 57 | 57 | 59 | 60 | 58 | 60 |
| (kg/m³) | | | | | | |
| 30% CFD | 90.3 | 76.0 | 80.5 | 82.4 | 90.7 | 110.2 |
| (kPa) | | | | | | |

What is claimed is:

1. A foamed isocyanate-based polymer derived from a reaction mixture comprising toluene diisocyanate, wherein the foam has a compression force deformation of at least about 50 kPa at 30% deflection when measured pursuant to ASTM 3574 and a density of less than about 45 kg/m³.

2. The foamed isocyanate-based polymer foam defined in claim 1, wherein the foam has a compression force deformation of at least about 70 kPa at 30% deflection when measured pursuant to ASTM 3574.

3. The foamed isocyanate-based polymer foam defined in claim 1, wherein the foam has a compression force deformation of at least about 120 kPa at 30% deflection when measured pursuant to ASTM 3574.

4. The foamed isocyanate-based polymer foam defined in claim 1, wherein the foam has a density in the range of from about 25 to about 45 kg/m³.

5. The foamed isocyanate-based polymer foam defined in claim 1, wherein the foam has a density in the range of from about 35 to about 45 kg/m³.

6. The foamed isocyanate-based polymer foam defined in claim 1, wherein the reaction mixture comprises toluene diisocyanate as the sole isocyanate.

7. The foamed isocyanate-based polymer foam defined in claim 1, wherein the reaction mixture comprises toluene diisocyanate and at least one other isocyanate.

8. The foamed isocyanate-based polymer foam defined in claim 7, wherein the reaction mixture comprises at least about 40% by weight toluene diisocyanate.

9. The foamed isocyanate-based polymer foam defined in claim 7, wherein the reaction mixture comprises at least about 75% by weight toluene diisocyanate.

10. The foamed isocyanate-based polymer foam defined in claim 1, wherein, the reaction mixture comprising toluene diisocyanate, an active hydrogen-containing compound, a dendritic macromolecule and a blowing agent.

11. The foamed isocyanate-based polymer foam defined in claim 10, wherein at least a 15% by weight of the dendritic macromolecule may be mixed with a polyether polyol having an OH number less than about 40 mg KOH/g to form a stable liquid at 23° C.

12. A process for producing a foamed isocyanate-based polymer comprising the steps of:
contacting an isocyanate comprising toluene diisocyanate, an active hydrogen-containing compound, a dendritic macromolecule and a blowing agent to form a reaction mixture; and
expanding the reaction mixture to produce the foamed isocyanate-based polymer;
wherein at least a 15% by weight of the dendritic macromolecule may be mixed with a polyether polyol having an OH number less than about 40 mg KOH/g to form a stable liquid at 23° C.

13. The process defined in claim 12, wherein the toluene diisocyanate as the sole isocyanate in the reaction mixture.

14. The process defined in claim 12, wherein the isocyanate comprises toluene diisocyanate and at least one other isocyanate.

15. The process defined in claim 12, wherein the reaction mixture comprises at least about 40% by weight toluene diisocyanate.

16. The process defined in claim 12, wherein the reaction mixture comprises at least about 75% by weight toluene diisocyanate.

17. The process defined in claim 14, wherein the at least one other isocyanate is selected from the group comprising 2,4′-diphenylmethane diisocyanate, 4,4′-diphenylmethane diisocyanate and mixtures thereof.

18. The process defined in claim 12, wherein the toluene diisocyanate is selected from the group comprising 2,4-toluene dilsocyanate, 2,6-toluene diisocyanate and mixtures thereof.

19. The process defined in claim 2, wherein the active hydrogen-containing compound comprises a polyol.

20. The process defined in claim 19, wherein the polyol comprises a polyether polyol.

21. The process defined in claim 12, wherein dendritic macromolecule has the following characteristics:
(i) an active hydrogen content of greater than about 3.8 mmol/g;
(ii) an active hydrogen functionality of at least about 8; and
(iii) at least a 15% by weight of the dendritic macromolecule may be mixed with a polyether polyol having an OH number less than about 40 mg KOH/g to form a stable liquid at 23° C.

22. The process defined in claim 21, wherein from about 15% to about 30% by weight of the dendritic macromolecule may be mixed with a polyether polyol having an OH number less than about 40 mg KOH/g to form a stable liquid at 23° C.

23. The process defined in claim 21, wherein at least a 15% by weight of the dendritic macromolecule may be mixed with a polyether polyol having an OH number in the range of from about 28 to 32 mg KOH/g to form a stable liquid at 23° C.

24. The process defined in claim 21, wherein the active hydrogen content of the macromolecule is in the range of from about 3.8 to about 10 mmol/g.

25. The process defined in claim 21, wherein the active hydrogen content of the macromolecule is in the range of from about 4.4 to about 5.7 mmol/g.

26. The process defined in claim 21, wherein the active hydrogen functionality in the macromolecule is in the range of from about 8 to about 70.

27. The process defined in claim 21, wherein the active hydrogen functionality in the macromolecule is in the range of from about 15 to about 35.

28. The process defined in claim 21, wherein from about 15% to about 50% by weight of the dendritic macromolecule may be mixed with a polyether polyol having an OH number less than about 40 mg KOH/g to form a stable liquid at 23° C.

29. The process defined in claim 21, wherein from about 15% to about 40% by weight of the dendritic macromolecule may be mixed with a polyether polyol having an OH number less than about 40 mg KOH/g to form a stable liquid at 23° C.

30. The process defined in claim 21, wherein the macromolecule has an inherently branched structure comprising at least one of an ester moiety, an ether moiety, an amine moiety, an amide moiety and any mixtures thereof.

31. The process defined in claim 21, wherein the macromolecule has an inherently branched structure comprising primarily an ester moiety, optionally combined with an ether moiety.

32. The process defined in claim 21, wherein the macromolecule has an inherently branched structure comprising primarily an ether moiety, optionally combined with an ester moiety.

33. The process defined in claim 21, wherein the macromolecule has an inherently branched structure comprising primarily an ester moiety, optionally combined with an ether moiety.

34. The process defined in claim 30, wherein the macromolecule further comprises nucleus to which the inherently branched structure is chemically bonded.

35. The process defined in claim 30, wherein a plurality of inherently branched structures are chemically bonded to one another.

36. The process defined in claim 30, wherein the inherently branched structure further comprises at least one chain stopper moiety chemically bonded thereto.

37. The process defined in claim 30, wherein the inherently branched structure further comprises at least two different chain stopper moieties chemically bonded thereto.

38. The process defined in claim 30, wherein the inherently branched structure further comprises at least one spacing chain extender chemically bonded thereto.

39. The process defined in claim 38, wherein the spacing chain extender is monomeric.

40. The process defined in claim 38, wherein the spacing chain extender is polymeric.
